(19) United States
(12) Patent Application Publication
(10) Pub. No.: US 2018/0202875 A1
(43) Pub. Date: Jul. 19, 2018

(54) TACTILE SENSOR WITH HOUSING

(71) Applicant: PILZ GMBH & CO. KG, OSTFILDERN (DE)

(72) Inventors: Onedin IBROCEVIC, OSTFILDERN (DE); Matthias KUCZERA, OSTFILDERN (DE)

(21) Appl. No.: 15/869,216

(22) Filed: Jan. 12, 2018

(30) Foreign Application Priority Data
Jan. 17, 2017 (DE) 10 2017 100 786.5

(51) Int. Cl. G01L 1/22

(52) U.S. Cl. CPC G01L 1/2287

(57) ABSTRACT

A tactile sensor comprising a housing containing a sensor unit with an active region comprising a first layer having a first electrode made of conductive yarn, a second layer having a second electrode, and an intermediate layer of pressure-sensitive material that spaces apart the first and second electrodes. The sensor unit extends essentially along a longitudinal direction L defined by the conductive yarn. The active region of the sensor unit is designed such that a compression of the pressure-sensitive material leads to a change in an electrical property between the first and second electrodes that can be detected by an evaluation unit. The housing comprises a main body, a compression body and a joining section. The compression body is designed to transfer a mechanical force acting thereon to the sensor unit. The housing extends along the longitudinal direction L and is formed in one piece from an elastic material.

### CROSS-REFERENCES TO RELATED APPLICATIONS

This application claims priority from German patent application DE 10 2017 100 786.5 filed on Jan. 17, 2017. The entire content of the priority application is incorporated herein by reference.

### BACKGROUND OF THE INVENTION

The present invention relates to a tactile sensor with a housing and means for closing an opening using such a sensor. The present invention further relates to a corresponding housing.

Automatic doors, gates or windows in building technology or vehicle doors in public passenger transport are generally equipped with a pinch protection means. The pinch protection means prevents obstacles from being clamped in on shear and pinch edges by stopping or reversing the risk-entailing movement upon detecting obstacles.

Simple systems achieve pinch protection in a partially mechanical manner by back or frictional couplings. In the case of more complex or more convenient systems with an automatic closing function, pinch protection is obtained by determining the drive torque in dependence on the window position. If a certain limit value of the drive torque is exceeded, the movement is stopped or the movement direction reversed in order to free an obstacle. In this case, it is necessary to determine from the position of the window or the door whether an obstacle is present or whether a defined end position has been reached. The pinch protection function is usually achieved directly via the drive controller, wherein the window position can be determined via Hall sensors on the motor shaft.

Moreover, it is known to use so-called safety bars as pinch protection means. Safety bars are sensors which are arranged along pinch and shear edges and can directly detect an obstacle at the edges. By comparison with the first-mentioned pinch protection devices, safety bars have the advantage that they directly detect an obstacle, instead of only indirectly. Depending on the switching principle, the safety bars have two conductive layers, a break-contact chain or an optoelectronic sensor, which, when an obstacle is stuck, cause an immediate stop or a reversal of the dangerous movement via a corresponding controller. Safety bars can be disposed either on the movable edge or on the respective stop of the movable edge. However, known safety bars have the disadvantage that they are only flexible to a limited degree and can thus essentially safeguard only straight edges.

Further, in the industrial field optical sensors, such as for example light barriers and light grids, are used to safeguard pinch and shear edges contactlessly. However, light grids and light barriers have the disadvantage that, in principle, they can only reliably safeguard straight edges. Other optical systems in turn which perform object detection on the basis of image processing are generally overdimensioned and too expensive for use as simple pinch protection means.

### SUMMARY OF THE INVENTION

It is an object of the present invention to specify a tactile sensor for monitoring pinch and shear edges that can be realized more simply. Further, it is an object to provide a tactile sensor that is flexible in the longitudinal and in the transverse direction in order to be able to safeguard bent or curved edges. Yet further, it is an object to specify a cost-effective sensor which can easily be installed and flexibly be used.

According to an aspect of the present invention, there is provided a tactile sensor comprising a sensor unit and a housing in which the sensor unit is disposed, the sensor unit comprising a first layer having a first electrode, a second layer having a second electrode, and an intermediate layer of pressure-sensitive material that spaces apart the first electrode from the second electrode, wherein at least the first electrode is made of conductive yarn which defines a longitudinal direction L along which the sensor unit essentially extends, wherein the first and second electrodes define, together with the pressure-sensitive material, an active region of the sensor unit that is designed such that a compression of the pressure-sensitive material in the active region leads to a change in an electrical property between the first and second electrodes that can be detected by an evaluation unit, wherein the housing comprises a main body, a compression body and a joining section, wherein the main body is designed to receive the sensor unit, the compression body is designed to transfer a mechanical force acting thereon to the sensor unit, and the joining section is designed to couple the sensor to a support, and wherein the housing with the main body, the compression body and the joining section extends along the longitudinal direction L and the housing is formed in one piece from an elastic material.

It is thus an idea to specify a tactile sensor with a sensor unit that is arranged in a corresponding housing.

The sensor unit is a multilayer tactile sensor with two electrodes that are spaced apart from one another by a pressure-sensitive material. At least one electrode is a thread of a conductive yarn. Preferably, both electrodes of the sensor unit are made of conductive yarn. An electrode of conductive yarn has the advantage that it can be bent in virtually any desired direction and a sensor is therefore not restricted to a straight line. Moreover, an electrode of conductive yarn can be designed to be particularly narrow with virtually any desired length, allowing a particularly narrow sensor that can be adapted optimally to an edge to be monitored.

This is further supported by the pressure-sensitive material that spaces the two electrodes apart from one another being adapted to the respective application. Furthermore, such a multilayer sensor can not only indicate a first and a second state in a binary manner but, in a preferred embodiment, may also deliver analogue or discretized values which correlate with the intensity or the location of the pressure loading.

The proposed housing enables the sensor unit to be assembled in a particularly simple manner to form a productive sensor. In particular, the housing allows the sensor unit itself to be produced without a special housing and thus in a particularly cost-effective manner. The one-piece design of the housing in turn makes it possible for the sensor to be shielded particularly well against external influences, while the production costs can be reduced to a minimum.

Overall, the sensor enables a particular good and effective monitoring of pinch and shear edges and can be used for monitoring non-straight edges. The sensor is narrow and lightweight and can preferably be arranged on moving components of an automatic door or of an automatic window.

In a further refinement, the sensor unit is tightly closed in the housing if the joining section is coupled to a support. As soon as the housing is placed on the support, the internal sensor unit is completely shielded, such that a high protection class (IP67) may advantageously be achieved.

In a further refinement, the joining section can be coupled to a support with a defined profile and comprises connecting elements which are shaped such that they engage in the profile of the support in order to produce a dirt-tight and watertight connection between the joining section and the profile. In this refinement, a section of the one-piece housing is shaped such that it can enter into a form-fit connection with the profile of a support. This allows particularly good and secure sealing of the sensor.

In a particularly preferred refinement, the connecting elements are designed such that they can be spread apart in order to be mounted on the profile of the support. This refinement has the advantage that the housing can be mounted preferably without tools.

In a further refinement, the main body comprises a receptacle for supporting the sensor unit, said receptacle comprising a slot-like opening with respect to the joining section, via which the sensor unit can be inserted into the housing. In this refinement, the joining section is connected to a receptacle in the main body via a slot-like opening, such that the receptacle, if the housing is not mounted on a corresponding profile, is accessible from outside. Thereby, the sensor unit can be fitted into the housing in a particularly simple manner without tools, possibly also by an end user. This allows particularly simple and user-friendly mounting of the tactile sensor. The slot-like opening preferably extends over the entire length of the sensor unit, such that the latter can be inserted in a particularly simple manner.

In a further refinement, the housing comprises a tightly closable connection region via which electrical contacts to the sensor unit can be fed, wherein the connection region comprises a clamping part for sealing or can be subsequently closed by potting. This refinement contributes to a further simplification of mounting in that the electrical contacts required for contacting the first and second electrodes can be led out of the housing in a simple manner, wherein the connection region can be easily sealed by a clamping part.

In a further refinement, the compression body extends over the entire active region of the sensor unit and the compression body is further designed to transfer a force uniformly to the sensor unit. In this refinement, a separate compression body is thus formed over the entire active length of the sensor unit and uniformly transfers to the sensor unit a mechanical force resulting from a collision with an obstacle, such that a particularly high sensitivity can be achieved.

In a further preferred refinement, the compression body comprises a curved surface which allows direct force transfer in order to achieve a high sensitivity of the sensor. In this refinement, the housing is thus rounded off on an upper side, such that a contact with said upper side is uniformly transferred to the main body situated below the compression body and to the sensor unit contained in said main body. The sensitivity of the sensor can be increased further still by means of this design.

In a further refinement, the housing is produced from foamed polyurethane with a compacted surface. This refinement contributes to a particularly cost-effective production of the sensor. Polyurethanes are plastics or synthetic resins which can be produced industrially and, as hard foam, can be brought into any desired shapes. The compacted surface allows the housing to be designed in a particularly robust manner against external influences without a further material or an additional component being required for the housing.

In a further refinement, the housing is dimensioned such that the length of the housing is at least a double-digit multiple of the width, in particular the width and the height, of the housing, wherein the length of the housing is defined by the extent in the longitudinal direction and the joining section, the main body and the compression body arranged above one another define the height of the housing. This refinement describes a preferred housing shape for a sensor formed essentially in a longitudinal direction. The housing is designed in such that it adapts to a narrow, thin and longitudinally directionally extended shape of the sensor unit. The small width and the small height of the sensor make the sensor particularly suitable for use as a pinch protection means on pinch and shear edges since the sensor protrudes only to a minor degree. In particular, the sensor has little influence on the visible area, especially when used with two glass doors that move towards one another.

In a further refinement, the width of the sensor is less than 1 cm, and preferably less than 0.7 cm and in particular 0.5 cm. These dimensions are particularly suitable so that the sensor can also be used on narrow doors or windows.

It will be understood that the aforementioned features and the features that are yet to be described can be used not only in the respectively specified combination, but also in other combinations or on their own, without departing from the scope of the present invention.

### BRIEF DESCRIPTION OF THE DRAWINGS

Exemplary embodiments of the invention are represented in the drawing and are described in detail in the subsequent description. In the figures:

FIG. 1 shows a first exemplary embodiment of the new sensor in a perspective view,

FIG. 2 shows a second exemplary embodiment of a new sensor in a cross-sectional view,

FIG. 3 shows a third exemplary embodiment of a new sensor in a cross-sectional view,

FIG. 4 shows a fourth exemplary embodiment of a new sensor in a cross-sectional view and in a top view,

FIG. 5 shows a fifth exemplary embodiment of the new sensor in a cross-sectional view and in a top view,

FIG. 6 shows an exemplary embodiment of a housing for a new sensor in a perspective view,

FIG. 7 shows the exemplary embodiment according to FIG. 6 in a cross-sectional view, and

FIG. 8 shows an example of an application of the new sensor.

### DESCRIPTION OF PREFERRED EMBODIMENTS

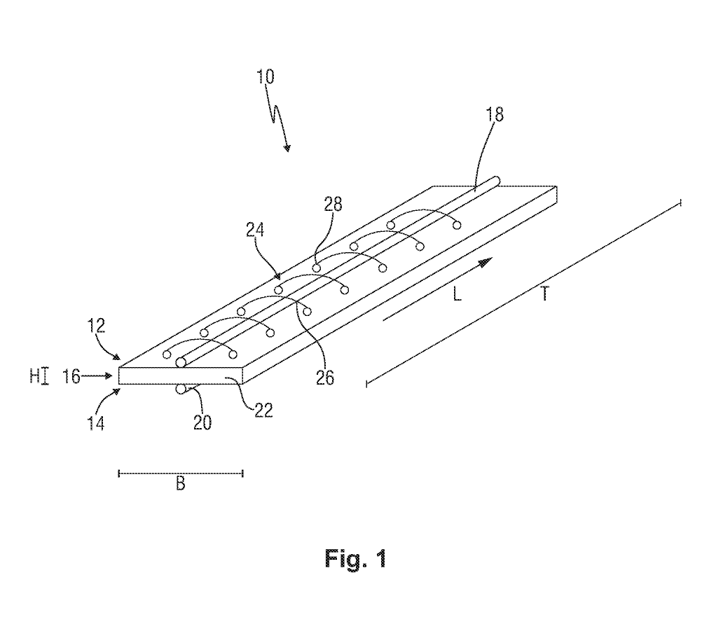

FIG. 1 shows a first exemplary embodiment of the sensor in a perspective view. The sensor is denoted here in its entirety with reference numeral 10. The sensor 10 is multi-layered and at least comprises a first layer 12, a second layer 14 and an intermediate layer 16 that is disposed between the first and the second layer. The first layer 12 comprises a first electrode 18 and the second layer 14 comprises a second electrode 20.

In this exemplary embodiment, the first and second electrode 18, 20 are made of electrically conductive yarn. In particular, the first and second electrode 18, 20 in this exemplary embodiment are each a thread of an electrically conductive yarn and thus flexible. In general, an electrically conductive yarn is a linear textile fabric that can be processed into weaves, knits, crocheting and embroidery and can particularly be used for sewing. Compared to a normal yarn, a conductive yarn is able to carry electric current. This can be achieved by spinning the yarn from conductive fibres, for example, stainless steel fibres. Alternatively, a conventional non-conductive thread can be made conductive by coating the thread with conductive material. For example, an ordinary nylon thread can be coated with silver in order to obtain a conductive thread. The different types of conductive yarn have different advantages and disadvantages regarding strength and conductivity, but can be used equally in relation to the new sensor. It is decisive that the thread is entirely conductive and at the same time retains its textile-like properties, in particular its flexibility and pliability.

In the exemplary embodiment according to FIG. 1, only a single electric thread is shown as the first electrode and as the second electrode 18, 20. This is a special case. In other embodiments, the first and second electrode 18, 20 may also be made from a plurality of electrically conductive threads. In the following, the special case as shown in FIG. 1 with only a single thread of conductive yarn as an electrode is referred to as a “single-yarn electrode”.

Further, in the exemplary embodiment according to FIG. 1, the first and second electrode 18, 20 are of the same design. It will be understood that this does not necessarily have to be the case and that in other embodiments an electrode in the first layer can be of a different design than an electrode in the second layer.

Having electrodes 18, 20 formed as yarn requires that the electrodes 18, 20 extend essentially in a longitudinal direction L. Nevertheless, the electrodes do not have to be straight. In fact, the electrodes may extend in an arc, depending on the geometry that the corresponding application requires.

The first and second electrode 18, 20 run parallel to each other in this exemplary embodiment and are spaced apart from each other by the intermediate layer 16. The intermediate layer 16 is made of a pressure-sensitive material 22. For example, the intermediate layer may comprise compressible elements that are forced apart if pressure is applied transverse to the electrodes 18, 20, so that the first and second electrode 18, 20 come into contact at the point of the pressure loading. Alternatively, a material that changes its electrical property between the first and second electrode 18, 20 under pressure may be used for the intermediate layer. In particular, a material can be used that changes its electrical resistance under pressure. Such an intermediate layer 16 may preferably be spread across the whole surface as shown here.

Regardless of its design, if pressure is applied perpendicularly to the intermediate layer 16, a changed electrical property between the first and second electrode 18, 20 may be detected by an analysis circuit (not shown here). In the special case of a sensor with a “single-yarn electrode” as represented in FIG. 1, the same working principle as with a pressure mat having electrodes extending in the surface applies.

Moreover, the new sensor comprises a fastening means 24 that holds at least the first electrode on the intermediate layer 16 in a defined position. The fastening means 24 comprises at least one first seam 26 that extends in the longitudinal direction L defined by the first electrode. This means that the seam 26 comprises entry and exit openings 28 that run in parallel to the first electrode 18. A thread is repeatedly fed multiple times through the pressure-sensitive material 22 through the entry and exit openings 28 in order to hold the first electrode 18 on the intermediate layer 16. In the exemplary embodiment shown here, for this purpose the thread is repeatedly passed over the first electrode, thereby pressing the electrode onto the intermediate layer 16.

It will be understood that in preferred embodiments, if the second electrode 20 is embodied in a similar way to the first electrode, the second electrode may also be fastened to the intermediate layer 16 by a seam. Particularly preferably, in this case the second electrode 20 is also hold by the first seam 26, so that only one fastening means 24 is necessary for the first and the second electrode 18, 20. The thread of the first seam 26 comprises similar properties in this case—apart from the conductivity—as the electrically conductive yarn of the first or second electrode 18, 20, so that the sensor as a whole retains the flexibility of the electrodes. Thus, the flexibility of the sensor is not significantly limited by the fastening means 24. At the same time the first electrode 18 is held in a defined position even during twisting or bending of the sensor 10.

Preferably, the sensor according to the invention is used as a strip-shaped sensor for protecting pinch and shear edges, for example in industrial production systems, automatic doors, gates or windows in building technology or vehicle doors in public passenger transport. A preferred sensor thus extends essentially in a longitudinal direction L, and a height H and a width B of the sensor are small in relation to its depth T. In preferred embodiments, the depth T is at least ten times the width B. Furthermore in a preferred embodiment, the sensor may be rolled up and applied like an adhesive tape. A sensor according to the invention may be produced as a continuous item which is cut into the final form by the end user. The robustness achieved by the individual fixing of the electrodes is not lost by this, since the robustness only depends on the design of the electrode and not on the geometry of the sensor.

It will be understood that the present invention is not limited to the aforementioned strip-shaped sensors, but an individual fixing can also be used with tactile sensors of other shapes having different geometries.

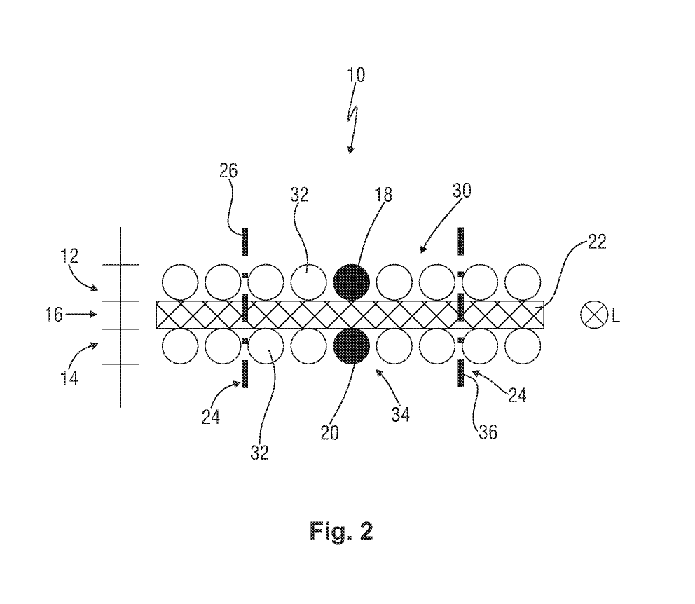

With reference to FIG. 2, a second exemplary embodiment of a sensor according to the invention is described. FIG. 2 shows a cross-sectional view of the new sensor. The same reference numerals denote the same parts as in the exemplary embodiment according to FIG. 1.

In contrast to the exemplary embodiment according to FIG. 1, the first and second layers are not exclusively made of an electrode of conductive yarn. In fact, the conductive electrodes 18, 20 are each part of a textile sheet. A first textile sheet 30 forms the first layer 12 and comprises further non-conductive threads 32 in addition to the first electrode 18 of electrically conductive yarn. The non-conductive threads 32 and the first electrode 18 extend in a longitudinal direction L in the plane of the figure and are woven with threads running transverse to the longitudinal direction in order to form a textile workpiece. The first sheet is thus a textile fabric that is made of conductive and non-conductive threads.

As with the first electrode 18, the second electrode 20 in this exemplary embodiment is also woven with non-conductive threads to form a second sheet 34. The first and second textile sheets 30, 34 are applied to opposite sides of the intermediate layer 16. The regions in which the first and second electrodes 18, 20 overlap form the active regions, in which compression of the pressure-sensitive material 22 of the intermediate layer 16 can be registered by the first and second electrodes 18, 20. In the exemplary embodiment shown here, the first electrode 18 and the second electrode 20 are disposed parallel to each other over their entire length, so that the active region is defined by the dimensioning of the first and second electrodes 18, 20. It will be understood that a different arrangement of the electrodes is conceivable. In particular, in other embodiments further electrodes may be provided that are disposed in a matrix in order to define pressure-sensitive cells that can be polled individually.

In the exemplary embodiment according to FIG. 2, a second seam 36 is provided besides the first seam 26, which together form the fastening means 24. In this exemplary embodiment, the thread of the first seam 26 and the thread of the second seam 36 are both fed through the first layer 12, the second layer 14 and the intermediate layer 16 repeatedly multiple times. The seams 26, 36 run along the longitudinal direction L parallel to the first and second electrodes 18, 20. Neither the first seam 26 nor the second seam 36 in this exemplary embodiment is directly connected to the first or the second electrode 18, 20 in order to fix the same. In fact, the first seam 26 and the second seam 36 are bound to the first textile sheet 30 and the second textile sheet 34 in order to be fixed to the intermediate layer 16. As both the first electrode 18 and the second electrode 20 are each woven into the first or second sheet 30, 34, the fastening means 24 fixes the first seam 26 and the second seam 36 and thus the electrodes in a defined position relative to each other. Thus, in this exemplary embodiment the electrodes are only fixed indirectly by means of the seams 26, 36.

The pliability of the sensor 10 primarily depends on the pliability of the individual layers 12, 14, 16 and is essentially not influenced by the first and second seams 26, 36. Nevertheless, the electrodes 18, 20 remain in a defined position, even during bending or twisting of the sensor. Since the seams in this exemplary embodiment cannot come into direct contact with the electrodes, the seams may also be of conductive yarn and may possibly contribute to the contacting of the electrodes or other components of the sensor.

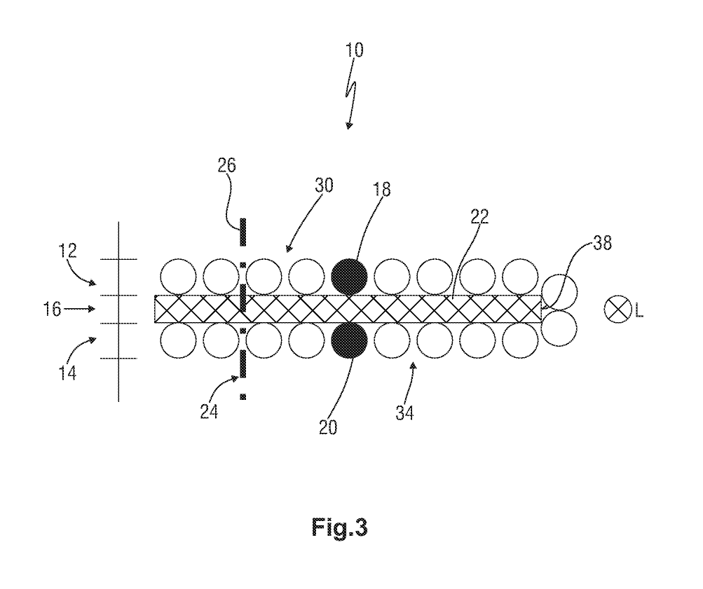

With reference to FIG. 3, a further refinement of the exemplary embodiment of FIG. 2 is described in detail below. FIG. 3 also shows the new sensor in a cross-sectional view, wherein the same reference numerals denote the same parts.

In the exemplary embodiment according to FIG. 3, the first electrode 18 and the second electrode 20 are also parts of a textile sheet. However, in contrast to the previously described example, the first sheet 30 and the second sheet 34 are sections of a common sheet that is folded about a lateral edge 38 of the pressure-sensitive material 22 of the intermediate layer 16. Thus, in this exemplary embodiment the first and second layers 12, 14 are formed as a result of folding a one-piece textile workpiece over itself. As with an envelope, the intermediate layer 16 of pressure-sensitive material 22 is inserted into the folded sheet. The sheet is preferably folded around the lateral edge 38 so that the first electrode 18 and the second electrode 20 lay one top of each other. The region in which the first electrode 18 and the second electrode 20 overlap is the active region of the sensor 10. In the exemplary embodiment shown here, the first electrode 18 and the second electrode 20 overlap over the entire length in the longitudinal direction L.

Further, in contrast to the aforementioned exemplary embodiment, according to FIG. 3 an individual seam 26 is provided as a fastening means 24. In this exemplary embodiment, the individual seam 26 runs parallel to the first and second electrode 18, 20 and the lateral edge 38. The seam 26 thus closes the envelope in which the pressure-sensitive material 22 of the layer 16 is inserted like a letter. Here the seam 26 fixes the first layer 12, the second layer 14 and the intermediate layer 16 together by passing the seam 26 through the first sheet 30, the second sheet 34 and the intermediate layer 16.

In this way, a band-shaped sensor according to the exemplary embodiment of FIG. 3 can be implemented particularly simply and inexpensively, because only one seam has to be put in place and only a one-piece workpiece with woven-in electrodes and an intermediate layer is necessary in addition to the seam.

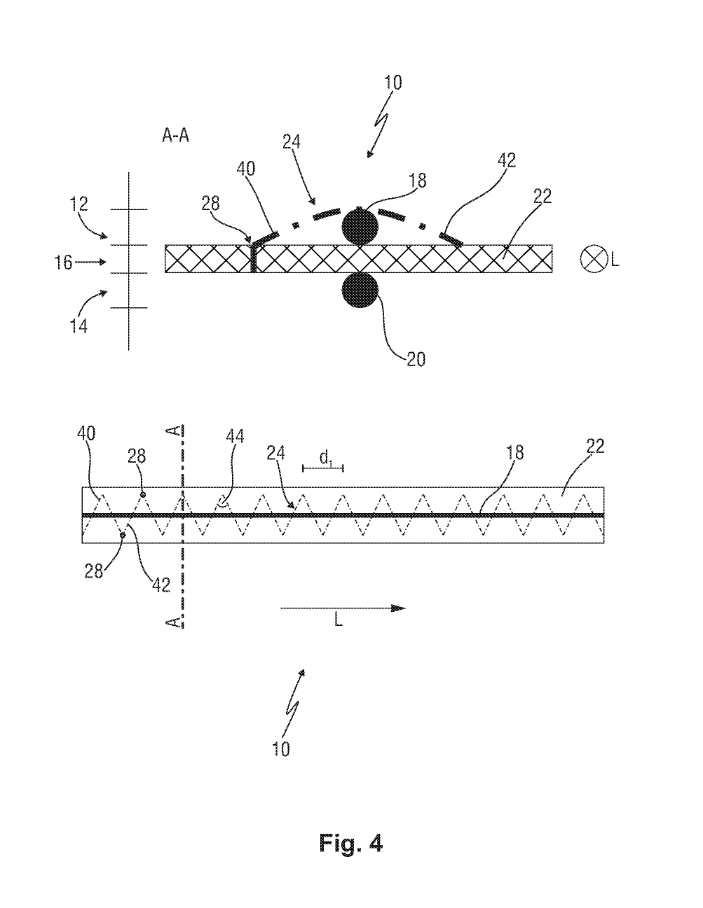

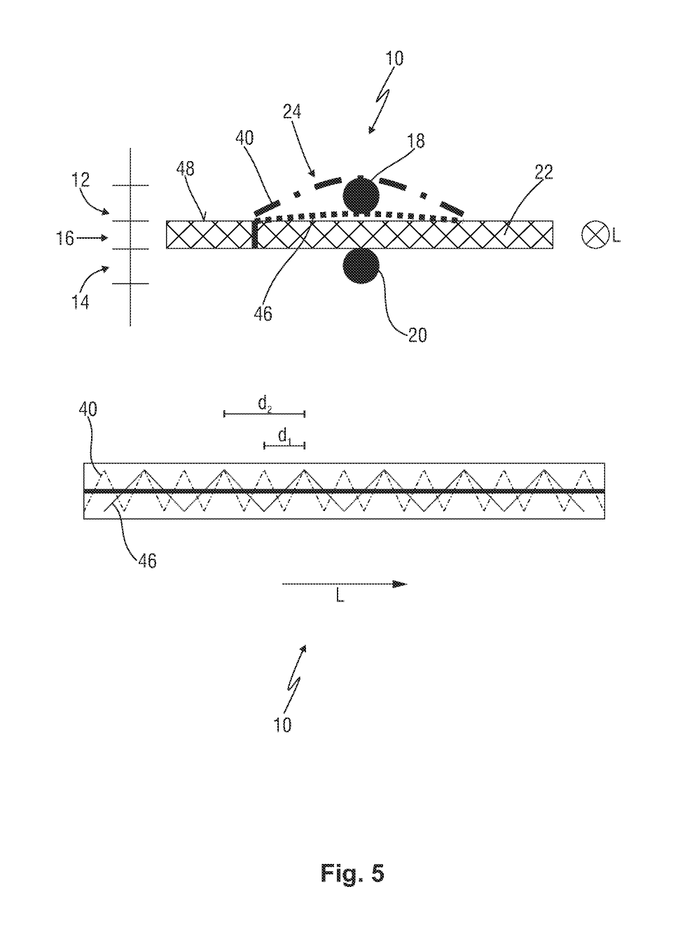

FIG. 4 and FIG. 5 show two further exemplary embodiments of the new sensor. FIG. 4 shows the new sensor both in a top view in the lower section and in a cross-sectional view in the upper half of the figure. The same reference numerals denote the same parts. Here, as in the exemplary embodiment according to FIG. 1, the sensor 10 comprises a single electrode in a first layer 12 and a single electrode in a second layer 14. Thus, both layers comprise a “single-yarn-electrode”. It will be understood, however, that fixing the electrodes as described in detail below is not limited to this design, but can also be used with electrodes of other designs. In particular, an electrode can also be composed of a plurality of threads that lay adjacent to each other, are twisted or woven.

As in the preceding exemplary embodiments, the first electrode 18 and the second electrode 20 are spaced apart from each other by an intermediate layer 16 of pressure-sensitive material 22. The first and second electrodes 18, 20 extend along a longitudinal direction L and thereby essentially determine the dimension of the sensor 10. The sensor 10 is thus a strip-shaped sensor that is relatively long, narrow and thin, and may for example be applied to narrow edges of doors or windows. The active region of the sensor corresponds to the region in which the first electrode 18 and the second electrode 20 overlap. A compression of the pressure-sensitive material 22 in the close surroundings of the first electrode and the second electrode 18, 20 can be detected by the sensor 10 by monitoring a change of an electric property between the first electrode 18 and the second electrode 20 caused by the compression.

The first electrode 18 is held on the intermediate layer 16 by a fastening means 24. The fastening means 24 comprises here a zigzag seam 40 with a thread that defines a first zigzag pattern. The thread is fed through the pressure-sensitive material 22, exits from an entry and exit opening 28 out of the pressure-sensitive material 22 and is fed via the first electrode 18 to a further entry and exit opening 28, through which it enters the pressure-sensitive material 22. The short sections 42 that the thread defines between the individual entry and exit openings 28 are concatenated at the same angles 44, so that the ends, i.e. the entry and exit openings 28, describe two parallel lines or arces with the first electrode 18 in between. The entry and exit openings 28 are preferably disposed on the respective side of the first electrode 18 at the same distance therefrom, so that the electrode is uniformly pressed onto the intermediate layer 16 by the short sections 42. In other words, the zigzag seam 40 crosses the first electrode 18 in the longitudinal direction L at a defined interval d₁. A zigzag seam 40 can be particularly simply produced by machine. At the same time, the first electrode 18 is optimally fixed in a predetermined position by the zigzag seam 40.

It will be understood that in addition to a zigzag pattern, a different seam pattern may be used, with which the first electrode 18 is pressed onto the intermediate layer 16 and fixed in a defined position. The zigzag pattern is preferred because it can be produced particularly easily. Moreover, in another embodiment the second electrode 20 can also be fixed to the intermediate layer 16 in the same way with a suitable seam.

FIG. 5 shows a refinement of the exemplary embodiment of the sensor according to FIG. 4. The same reference numerals refer to the same parts. FIG. 5 shows the sensor 10 both in a top view (at the bottom) and also in a sectional view (at the top).

As in the preceding exemplary embodiment, the first and second layer 12, 14 each comprise a single electrode 18, 20 and are spaced apart from each other by an intermediate layer 16 of pressure-sensitive material 22. The first electrode 18 is held on the intermediate layer 16 by a first zigzag seam 40.

In addition to the preceding exemplary embodiment, the fastening means 24 comprises a second zigzag seam 46 in addition to the first zigzag seam 40. As with the first zigzag seam 40, the second zigzag seam 46 also extends in the longitudinal direction L defined by the first electrode 18. In contrast to the first zigzag seam 40, the second zigzag seam 46 is disposed below the first electrode 18 between the first electrode 18 and the intermediate layer 16. In other words, the second zigzag seam 46 directly contacts the surface of the intermediate layer 16. Further, the second zigzag seam 46 crosses here the first electrode 18 at a defined interval d₂. Thus, the first electrode 18 does not lie directly on the first intermediate layer 16 at the crossing points, but is supported by the second zigzag seam 46.

The second zigzag seam 46 consequently acts as a spacer in this exemplary embodiment, by which the sensitivity of the sensor 10 can be adjusted. By increasing the number of supporting points, the sensor 10 can be adjusted so that a greater pressure must be exerted on the electrode 18 and the intermediate layer 16 in order to cause a change in the electrical properties between the first electrode 18 and the second electrode 20. In particular, a high pressing force that is exerted on the first electrode 18 by the first zigzag seam 40 can be compensated and balanced by the second zigzag seam 46.

Overall, the sensitivity of the sensor can be advantageously adjusted by varying the distances of the supporting points and/or the distances of the overlappings of the first and second zigzag seams 40, 46. Thus, the fastening means 24 is used in this exemplary embodiment not only as an individual fixing of an electrode, but also as the adjustment means for controlling the sensitivity of the sensor. It is conceivable that in other embodiments an interval of the supporting points (d₂) or an interval of the overlappings (d₁) can be varied in the longitudinal direction L in order to provide a different sensitivity at different points of the sensor. Thus, different regions of the sensor can be provided with different sensitivity by means of the fastening means 24 alone. It will be understood that a different seam than a zigzag seam may be used in another embodiment for fastening or as a spacer.

Whereas the fastening means 24 has been described in the present exemplary embodiments for the first electrode 18, it is also conceivable that the same fastening means 24 may be used for the second electrode 20. It is also conceivable that the different fastening means of the individual exemplary embodiments may be combined with each other. For example, a zigzag seam may also be used if the first and/or the second layer are a textile sheet. Moreover, it is conceivable that a first fastening means 24 is used for the first layer 12 and a different fastening means is used for the second layer 14. In this respect, the individual fastening means for each layer can be varied at will. It will also be understood that the exemplary embodiments shown are particularly suitable for the special case of a “single-yarn electrode”, but may also be used for electrodes that are made up of a plurality of threads of conductive yarn.

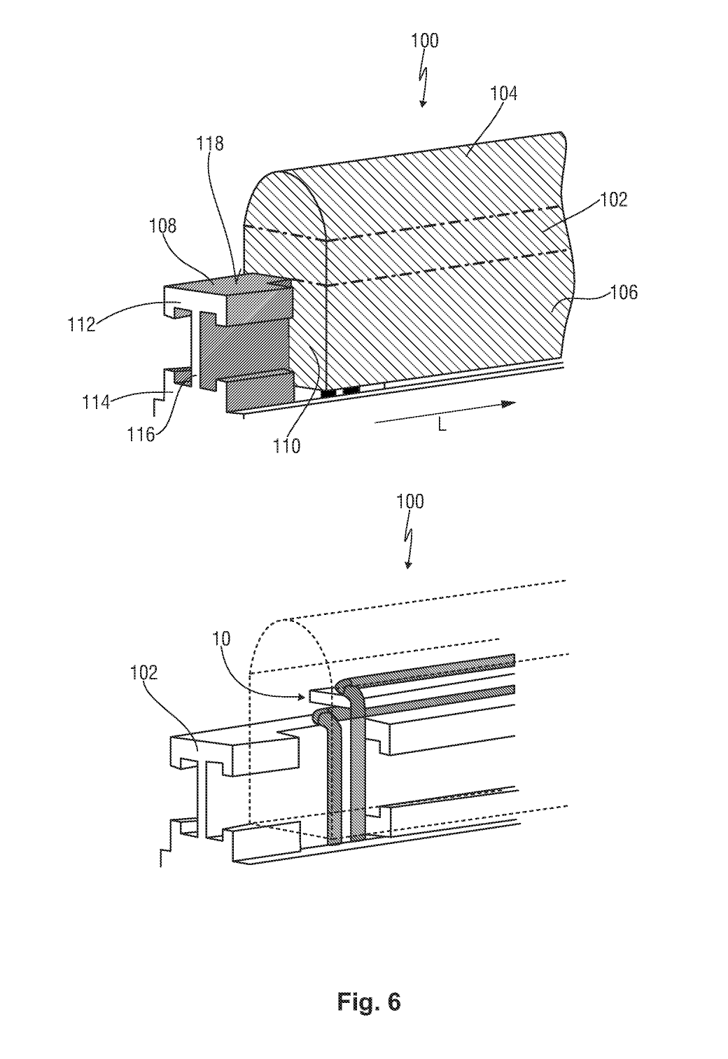

With reference to FIG. 6, a preferred exemplary embodiment of a housing for a sensor that has been disclosed above is described below. The housing is particularly designed for fastening and for protecting a strip-shaped sensor. FIG. 6 shows in two images the sensor in a perspective view. The upper image shows the housing in a closed form, whereas the lower image shows a view into the interior of the housing, wherein the external contours are represented here by dashed lines. In both images the same reference numerals refer to the same parts.

The housing, which is referred to in its entirety with the reference numeral 100, is divided into a basic body 102, a compression body 104 and a joining section 106. Because the housing is made as one piece of elastic material, the compression body 104, the basic body 102 and the joining section 106 transition seamlessly into each other. A strip-shaped sensor unit 10 is disposed within the sensor 100, more accurately speaking within the basic body 102. The strip-shaped sensor unit 10 is preferably a sensor, as has been previously described with reference to FIGS. 1 to 5. In particular, it is thus a sensor that comprises at least one electrode of conductive yarn. Representative of such a sensor indicated here is the special case with a “single-yarn electrode”. As with the sensor to be housed, the housing 100 extends essentially along a longitudinal direction L.

The housing 100 is mounted together with the sensor unit 10 on a support 108 that is not part of the housing but that works in conjunction with the housing in order to support the sensor 10 suitably and to shield it against external influences. The housing 100 is preferably form-fitted with the support 108. For this purpose, the housing comprises connecting elements 110 in the joining section 106 that are shaped so as to engage a positive-locking in the support 108. The support 108 is thereby preferably an oblong profile, to the external shape of which the connecting elements 110 are matched.

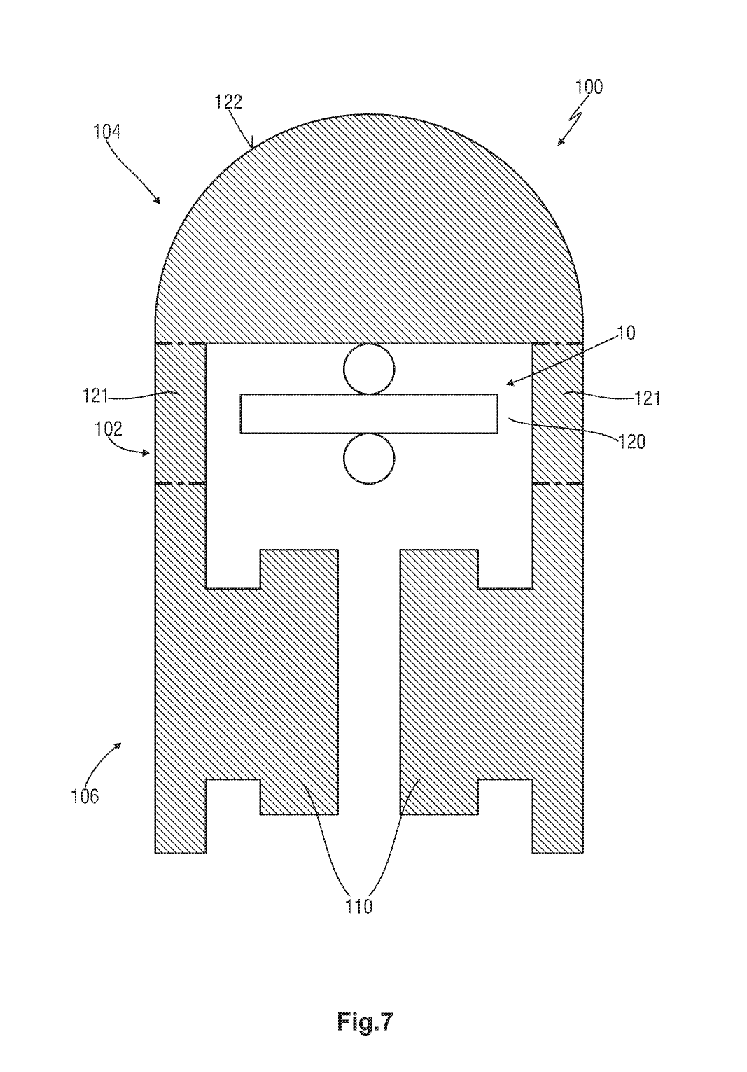

In the exemplary embodiment shown here, the support 108 is a double-T-profile with an upper flange 112 and a lower flange 114 and a central pillar 116 joining the two flanges. The upper flange 112 has a flat surface 118 that acts as the supporting surface for the sensor unit 10. The surface 118 thus forms a stable and uniform base for the sensor unit 10. Furthermore, the housing 100 encloses the supporting surface 118 together with the sensor unit 10. The sensor unit 10 is thus tightly enclosed in the housing 100. By means of the compression body 104, shocks are uniformly transferred to the sensor unit 10. The specific form of the basic body 102, the compression body 104 and the joining section 106 and the functions thereof are described in detail below with reference to FIG. 7.

FIG. 7 shows the exemplary embodiment of the housing according to FIG. 6 in a cross-section. The same reference numerals refer to the same parts. The partitioning of the housing 100 into the compression body 104, the basic body 102 and the joining section 106 is indicated by the dashed lines. As previously described, in this exemplary embodiment the joining section 106 comprises two connecting elements 110, by means of which a positive-locking connection to a support (not shown here) can be enabled. The connecting elements 110 are designed to be spread apart in order to be mounted on a support.

The basic body 102 comprises a receptacle 120 into which the sensor unit 10 can be inserted. The receptacle 120 is closed at the top by the compression body 104 and on the side by side parts 121 that correspond to the height of the sensor unit 10. In the lower section, i.e. in the transition to the joining section 106, the receptacle 120 is preferably open, so that the sensor unit 10 can be inserted into the basic body 102 through the joining section 106. As with mounting on a support, for this purpose the connecting elements 110 are spread apart and the sensor unit 10 is inserted into the receptacle 120. This way, the sensor unit 10 can be assembled without tools.

In the mounted state, i.e. when the housing 100 is placed on a support, the connecting elements 110 seal the receptacle 120 against water and dirt, so that the sensor is protected against external influences. Preferably, a sensor may thus be produced with a protection class of IP67. In regions in which the electrical contacts to the sensor unit 10 are fed, which is preferably carried out at the top of the sensor, the sealing can be guaranteed with a matching clamping part (not shown here) or by subsequent potting.

The compression region 104 is designed to transfer forces acting on the surface 122 of the compression body 104 to the strip-shaped sensor unit 10. At the same time, the compression body 104 is embodied to suitably attenuate shocks on the sensor 10 so that the sensor unit 10 can be inserted into the receptacle 120 without a further surrounding housing. The compression body is relatively thick compared to the rest of the housing and is designed to be soft and preferably comprises a curved surface 122. The curved surface 122 has the advantage that force acting thereupon is transferred to the sensor 10 uniformly. The sensitivity of the sensor 10 is advantageously increased as a result.

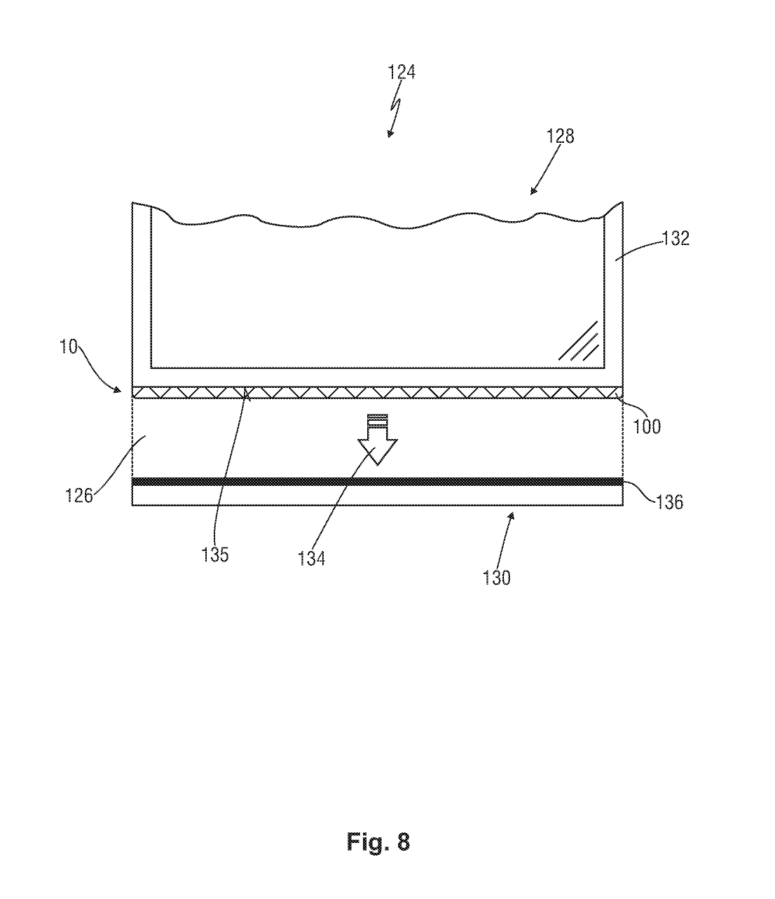

The material from which the housing 110 is made as one piece is preferably foamed polyurethane with a sealed surface. The dimensions of the housing 100 are essentially determined by the sensor unit 10 which is being used. The length of the housing, i.e. in this case the extent in the plane of the figure, is preferably at least a double-digit multiple of the width or the height thereof. The height of the housing is essentially defined by the compression body 104 and the joining section 106, whereas the basic body 102 is as narrow as the sensor unit 10 can be implemented and thus does not contribute significantly to the height. Particularly preferably, the width B of the sensor is less than 1 cm and preferably less than 0.7 cm and in particular 0.5 cm. The sensor is thus particularly good for use as a pinch protection means for automatic doors, gates and windows or for determining whether such automatic doors, gates and window are tightly sealed. A specific application example is described below with reference to FIG. 8.

FIG. 8 shows an automatically closing window 124 on which a sensor 10 according to the invention is disposed. The window 124 is designed to close an opening 126 and has a first part 128 and a second part 130. The first part 128 is a window pane that is disposed in a frame 132 that is movable along the direction of motion represented by the arrow 134. The second part 130 forms the stop with which a lateral edge 135 of the frame 132 comes into flush contact if the window 124 is closing the opening 126.

An embodiment of the new sensor is disposed on said lateral edge 135 on the frame 132 over the entire length. The sensor 10 is designed here to detect whether the opening 126 is fully closed. In another embodiment, the second part 130, which is designed here as a stop and is fixed, may also be movable. The second part 130 preferably comprises a sealing lip 136 that is designed similarly to the housing 100 of the new sensor 10 in cross-section. Thereby, the sealing lip 136 and the housing 100 may act as a seal.

The new sensor enables the sealing of a door, a gate or a window to be checked in a simple way based on a tactile principle. In particular, if the sensor unit 10 is designed to also determine in addition to a load itself the strength thereof or the distribution thereof over the sensor, the sensor can advantageously be used for different applications at the same time, such as for example testing of a sealing and clamping protection.

What is claimed is:

1. Tactile sensor comprising a sensor unit and a housing, in which the sensor unit is disposed, the sensor unit comprising a first layer having a first electrode, a second layer having a second electrode, and an intermediate layer of pressure-sensitive material that spaces apart the first electrode from the second electrode,
wherein at least the first electrode is made of conductive yarn that defines a longitudinal direction L, along which the sensor unit essentially extends,
wherein the first and second electrodes define, together with the pressure-sensitive material, an active region of the sensor unit that is designed such that a compression of the pressure-sensitive material in the active region leads to a change in an electrical property between the first and second electrodes which can be detected by an evaluation unit,
wherein the housing comprises a main body, a compression body and a joining section, wherein the main body is designed to receive the sensor unit, the compression body is designed to transfer a mechanical force acting thereon to the sensor unit, and the joining section is designed to couple the housing to a support, and
wherein the housing with main body, compression body and joining section extends along the longitudinal direction L and the housing is formed in one piece from an elastic material.

2. Tactile sensor according to claim 1, wherein the sensor unit is arranged tightly closed in the housing if the joining section is coupled to a support.

3. Tactile sensor according to claim 1, wherein the joining section can be coupled to a support with a defined profile and comprises connecting elements which are shaped such that they can engage in the profile of the support in order to produce a dirt-tight and watertight connection between the joining section and the profile.

4. Tactile sensor according to claim 3, wherein the connecting elements are designed such that they can be spread apart in order to be mounted on the profile of the support.

5. Tactile sensor according to claim 1, wherein the housing comprises a tightly closable connection region via which electrical contacts to the sensor unit can be fed, and the tightly closable connection region comprises a clamping part for sealing or can be subsequently closed by potting.

6. Tactile sensor according to claim 5, wherein the main body comprises a receptacle for supporting the sensor unit, said receptacle comprising a slot-like opening with respect to the joining section, via which opening the sensor unit can be inserted into the housing.

7. sensor according to claim 1, wherein the compression body extends over the entire active region of the sensor unit and is further designed to transfer a force uniformly to the sensor unit.

8. Tactile sensor according to claim 1, wherein the compression body comprises a curved surface which allows direct force transfer in order to achieve a high sensitivity of the sensor.

9. Tactile sensor according to claim 1, wherein the housing is produced from foamed polyurethane with a compacted surface.

10. Tactile sensor according to claim 1, wherein the housing is dimensioned such that the length of the housing is at least a double-digit multiple of the width, in particular the width and the height, of the housing, wherein the longitudinal direction L defines the length of the housing and the joining section, the main body and the compression body arranged above one another define the height of the housing.

11. Tactile sensor according to claim 1, wherein the width of the sensor is less than 1 cm.

12. Tactile sensor according to claim 11, wherein the width of the sensor is less than 0.7 cm.

13. Tactile sensor according to claim 12, wherein the width of the sensor is approximately 0.5 cm.

14. Apparatus for closing an opening comprising a first part with a first lateral edge, a second part with a second lateral edge which is movable with respect to the first lateral edge, and a tactile sensor comprising a sensor unit and a housing, in which the sensor unit is disposed, the sensor unit comprising a first layer having a first electrode, a second layer having a second electrode, and an intermediate layer of pressure-sensitive material that spaces apart the first electrode from the second electrode,
wherein at least the first electrode is made of conductive yarn that defines a longitudinal direction L, along which the sensor unit essentially extends,
wherein the first and second electrodes define, together with the pressure-sensitive material, an active region of the sensor unit that is designed such that a compression of the pressure-sensitive material in the active region leads to a change in an electrical property between the first and second electrodes which can be detected by an evaluation unit,
wherein the housing comprises a main body, a compression body and a joining section, wherein the main body is designed to receive the sensor unit, the compression body is designed to transfer a mechanical force acting thereon to the sensor unit, and the joining section is designed to couple the housing to a support,
wherein the housing with main body, compression body and joining section extends along the longitudinal direction L and the housing is formed in one piece from an elastic material, and
wherein the sensor is disposed along the first or second lateral edge, preferably over the entire length of the respective lateral edge, in order to monitor a closing of the means.

15. Apparatus according to claim 14, wherein the first and second lateral edge are arranged with respect to one another in a closed position such that the opening is closed in a light-tight manner and wherein the sensor is designed to verify the light-tight closing.

16. Apparatus according to claim 14, wherein the sensor is further designed to detect an obstacle in the opening in a tactile manner during closing.

17. Housing for receiving a sensor unit of a tactile sensor, said sensor unit comprising a first layer having a first electrode, a second layer having a second electrode, and an intermediate layer of pressure-sensitive material that spaces apart the first electrode from the second electrode,
wherein at least the first electrode is made of conductive yarn that defines a longitudinal direction L, along which the sensor unit essentially extends,
wherein the housing comprises a main body, a compression body and a joining section and the main body is designed to receive the sensor unit, the compression body is designed to transfer a mechanical force acting thereon to the sensor unit, and the joining section is designed to couple the housing to a support, and
wherein the housing with main body, compression body and joining section extends along the longitudinal direction L and the housing is formed in one piece from an elastic material.
